(19) United States
(12) Patent Application Publication
(10) Pub. No.: US 2004/0088420 A1
(43) Pub. Date: May 6, 2004

(54) System and method for electronic scrapbooking

(76) Inventors: Bradley Paul Allen, Shorewood, WI (US); Stephanie Ann Allen, Shorewood, WI (US)

Correspondence Address: Bradley P. Allen, 4508 N. Bartlett Ave., Shorewood, WI, 53211, US

(21) Appl. No.: 10/283,582

(22) Filed: Oct. 30, 2002

(51) Int. Cl. G06F 15/173; G06F 15/16

(52) U.S. Cl. 709/229; 709/225

(57) ABSTRACT

The present invention is a system and method for allowing individuals or a group of individuals to electronically scrapbook using materials either scanned into the system by the purchaser(s) of the service and/or the seller/vendor of the service. The purchaser(s) is provided an e-space by the seller/vender where he/she may create and store an electronic scrapbook. Additionally, the system will enable the purchaser(s) to utilize available templates, graphics, text, designs and other materials to create custom designed scrapbooks that are accessible by others over an electronic communication system or media, such as the internet. The scrapbook may be created by an individual or a group interacting via the internet. The seller/vendor will provide access codes to the e-space for people designated by the purchaser(s) which will allow the scrapbook to be printed.

### FIELD OF THE INVENTION

The present invention relates to establishing a system and method for allowing individuals or a group of individuals to electronically scrapbook using materials either scanned in by the purchaser(s) of the service and/or the seller of the service. Additionally, the present invention will allow the purchaser to utilize available templates, graphics and other materials to create custom designed scrapbooks that are accessible by others of the electronic media, such as the Internet.

### BACKGROUND OF THE INVENTION

Within the past couple of years, the collection and organizing of certain materials such as pictures and other materials into scrapbook format has become very popular. Many people collect various family materials and combined them with printed graphics, designs, stamps and other formats to create artistic and attractive scrapbooks that can be shared with other family members and friends. Not only are these scrapbooks used for family mementos and keepsakes, but they also have been used for memory books for people who are experiencing cognitive changes such as those people with Alzheimer's disease.

Currently, the primary form of scrapbooking is in hardcopy or paper medium. That is, scrapbooks tend to be in the form of paper books or other materials which are expensive to create and maintain. They also require a great deal of time to obtain materials and manually construct. This may be difficult especially for people with physical limitations or limited transportation. Additionally the scrapbooks must be moved manually or physically to others so that they can enjoy them.

This present invention allows the creation and posting of scrapbooks electronically so that many people have access to them even though they may live long distances away. Additionally, people may share scrapbooks and/or create a community scrapbook on-line, using various templates and formats available or by scanning into the system in their own material.

Such a method and system will not only facilitate the creation of a family memento by allowing family members over great distances to interact freely and regularly, but also provide a forum from which various individuals can visit and interact in a leisurely and recreational manner.

### SUMMARY OF THE INVENTION

The present invention facilitates the process of scrapbooking by allowing individuals to create and access the electronic scrapbook via the Internet.

The present invention is accomplished by the creation of an “e-space” for the purchaser or group of purchasers. These spaces may be arranged into a set of files that are organized and/or structured according to the format designated by the member user(s). These materials may come from the three following sources: 1) they may be scanned in by the purchaser/user; 2) they may be scanned in by the vendor of the scrapbooking services per the request of the purchaser; and 3) they may already exist on the site as available templates, designs, text, symbols and graphics.

Purchasers or purchaser's members can conveniently access the space from anywhere in the world simply by accessing a computer network such as the Internet. This present inventions provides a convenient and simple way for people to share family mementos, photographs and events. Additionally, the scrapbook may be downloaded and printed into a hardcopy for designated users.

The present invention also allows for the vendor/seller to control access at the purchasers' request. This may be done by the seller/vendor providing access codes to either purchasers and/or specified/designated individuals.

### BRIEF DESCRIPTION OF THE DRAWINGS

FIG. 1 depicts a block diagram illustrating a system architecture for implementing the present invention.

FIG. 2 depicts a block diagram illustrating the logical relationships between the Server, User Members and Designated Users.

FIG. 3 depicts a sports theme scrapbook template illustrating graphics that would be available for User Members to use to create custom pages by inserting photographs and/or other materials.

FIG. 4 depicts a baby shower theme scrapbook template illustrating designs that would be available for User Members to use to create custom pages by inserting photographs and/or other materials.

FIG. 5 depicts a scrapbook page template illustrating graphics that would be available for User Members to use to create custom pages by inserting photographs and/or other materials.

### DETAILED DESCRIPTION OF THE PRESENT INVENTION

The present invention is a system and method for allowing individuals or a group of individuals to electronically scrapbook using materials either scanned into the system by the purchaser(s) of the service and/or the seller/vendor of the service.

The purchaser(s) is provided an e-space by the seller/vender where he/she may create and store an electronic scrapbook. Additionally, the system will enable the purchaser(s) to utilize available templates, graphics, text, designs and other materials to create custom designed scrapbooks that are accessible by others over an electronic communication system or media, such as the internet.

The scrapbook may be created by an individual or a group interacting via the internet. The seller/vendor will provide access codes to the e-space for people designated by the purchaser(s) and will allow the scrapbook to be printed.

The purchaser(s) (herein referred to as user members) will undergo a registration process at which time they will receive information on how to use the service and the purchaser and vender will sign a “Electronic Commerce Service and Software Agreement.” This agreement will contain the following elements: scope of agreement; terms of agreement; charges; availability of services; use of services; modification of services; communications lines and equipment; file security, retention and transfer at time of termination; client's agreement with users; warranty and limitation of liability; defaults: remedies upon default; forms; trade secrets, confidentiality, and title; reliance on information provided; use of trademarks and service marks; government regulation; insurance; indemnification; contingency back-up.

The present invention is accomplished by the creation of an “e-space” for the user member. The e-space is a set of data files that are associated with the user members. The e-space is stored in a central location that can be accessed conveniently by individuals anywhere in the world at anytime. For example, data files in an e-space can include the user members' photographs, text, graphics, designs, scrapbook pages, e-mails and other materials that would be applicable to the creation of a scrapbook.

Member users or their designees can conveniently access the e-space from anywhere in the world simply by accessing a computer network such as the Internet. Thus, the present invention allows family members and friends to both review, enjoy and contribute to a family scrapbook from anywhere in the world.

The present invention also allows the user members to maintain their privacy by controlling access to the e-space. This is accomplished by providing the user members with the ability to specify varying levels of access privileges for designated individuals to review the scrapbook. In order to contribute to the scrapbook, however, the person(s) must register as a user member with the approval of the primary user member who initially purchased the service.

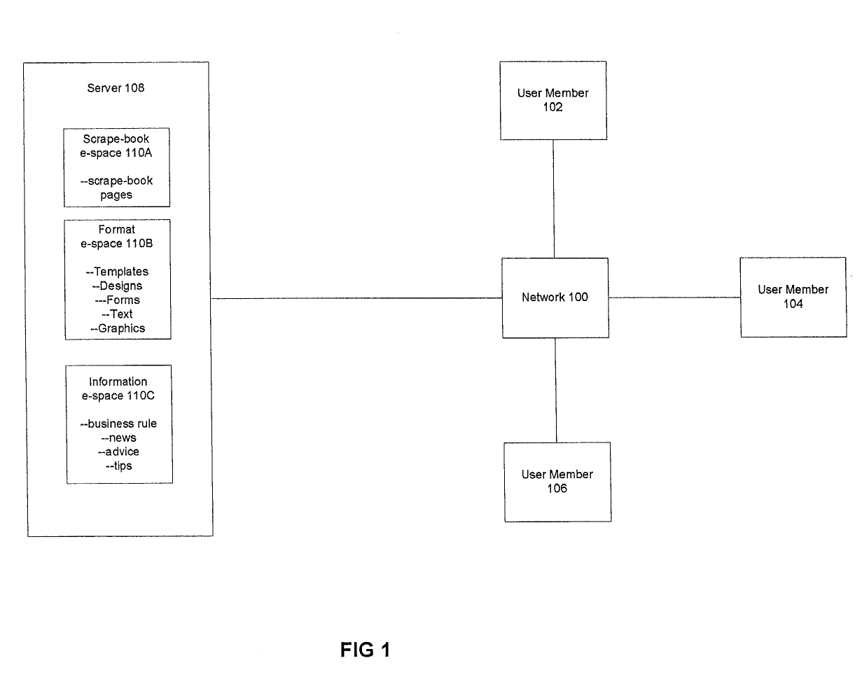

FIG. 1 depicts a blocks diagram for system architecture suitable for implementing the present invention. A server 108 runs a software program which implements the present invention. Server 108 includes a data storage device which stores a database comprise do three components: scrapbook e-space for user members; format e-space; and information e-space. For purposes of example, some typical types of data files that can be included in the forms e-space are depicted in FIG. 1 as templates, designs, forms, text, graphics.

Server 108 connects to network 100. Network 100 can be any network or communication media connecting terminals or user interface devices. For example, network 100 could be an intranet such as a local area network (LAN), or it could be a wide area network (WAN) such as the Internet. In one actualization of the present invention, network 100 is the Internet which allows individuals from anywhere in the world to conveniently access the e-space. As an alternative to the Internet, any computer network or other communication media could be used to connect member users with the scrapbook e-space.

User members such as family member 102, family member 104 and friend 106 can access the scrapbook e-space by using user interface devices at respective locations 102-104. User interface devices allow users to interact with network 100. Examples of user interface devices include computers, wireless devices, personal digital assistants (PDA's), cellular phones, and so forth. In one embodiment of the present invention, server 108 is connected to the World Wide Web. Any World Wide Web user can access the scrapbook e-space by entering a URL associated with server 108 such as http://www.electronicscrapbook.com. The user then enters his or her log-in information to access the system.

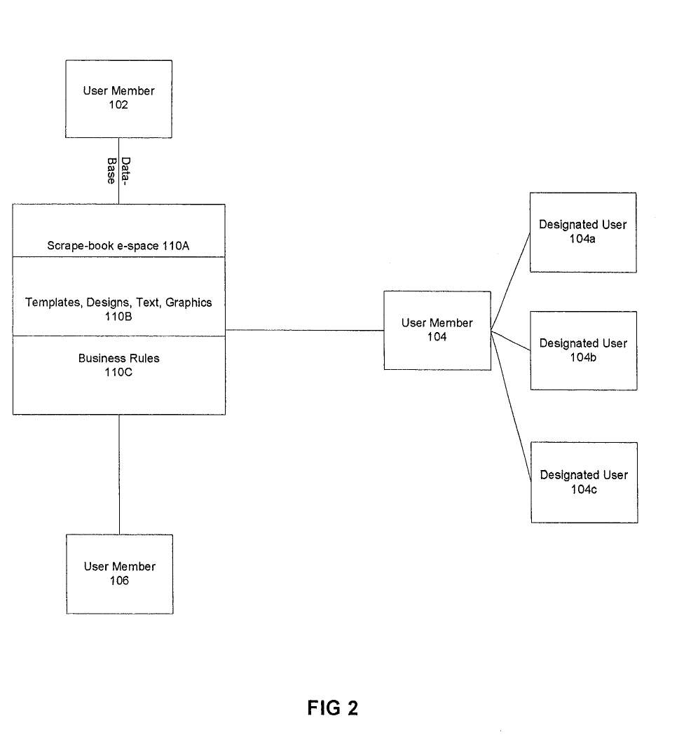

FIG. 2 depicts a block diagram which illustrates the logical relationships between the database, user member(s) and designated user(s). The user members are shown surrounding the centralized scrapbook e-space 200. This illustrates that all of the user members can access one centralized data space from diverse locations. Also, the designated user(s) will access the system via the user member's portal which will allow them to view the contents, but not contribute to it.

Business rules 110C are also associated with the scrapbook e-space 100A and 100B. Business rules 110C are rules that define access privileges for each user member or designated user.

A simple business rule can specify whether an individual has privileges to view a file, and/or to edit a file. More complex business rules could specify whether an user member or designated user can read a file, write to a file, delete entries in a file, or perform other types of operations, as specified.

The system of the present invention has a server administrator who grants access privileges. In a typical computer network, a server administrator is responsible for maintaining one or more central servers. The server administrator grants access privileges to the users of the computer network to allow the users to have limited access to the central server.

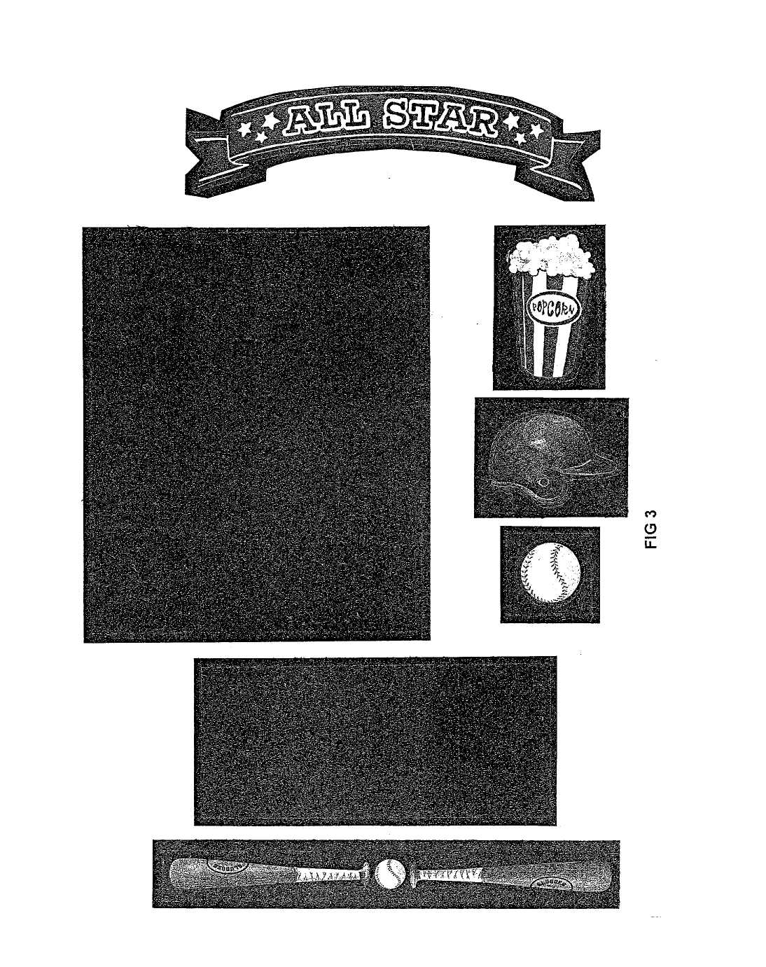

FIG. 3 depicts an example of a template that the user member can combine with other materials such as photographs to create custom scrapbook pages. This template can be stored in an electronic scrapbook file, combined with other pages and revised a at any time.

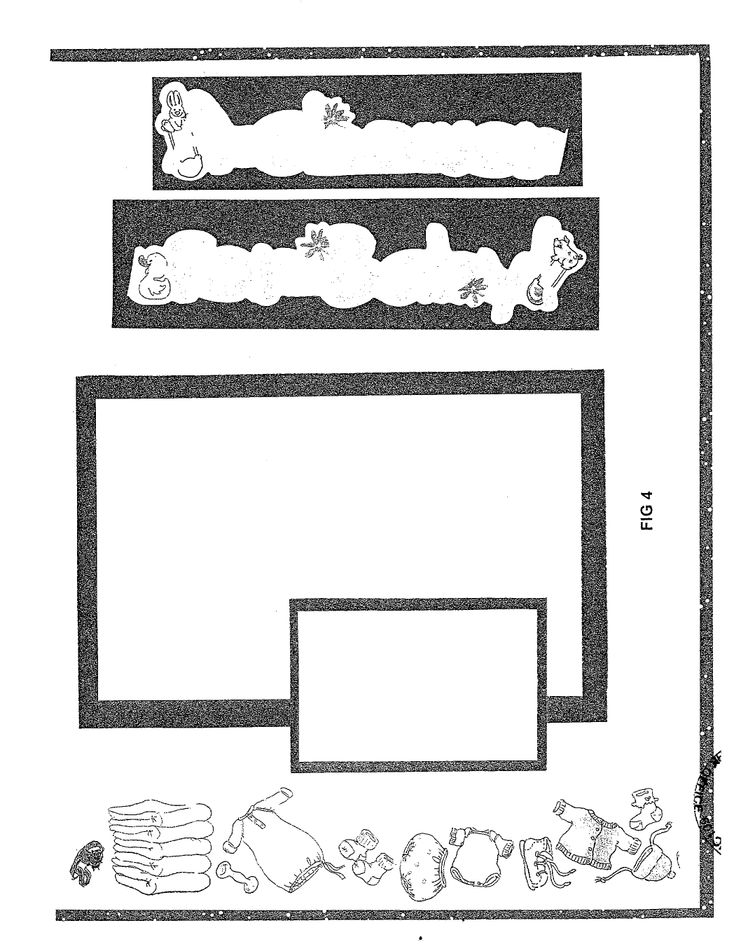

FIG. 4 depicts an example of a design based upon a baby shower theme. The user member can combine with it other materials such as photographs to create custom scrapbook pages. This page can be stored in an electronic scrapbook file, combined with other pages and revised at any time.

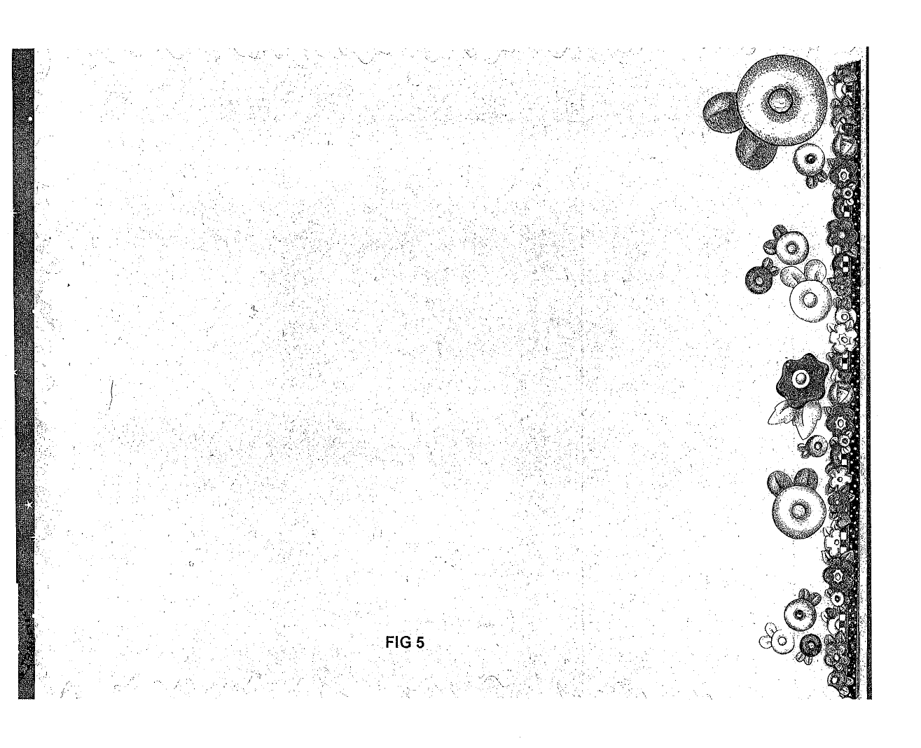

FIG. 5 depicts an example of a page with graphic designs that the user member can combine with other materials such as photographs to create custom scrapbook pages. This page can be stored in an electronic scrapbook file, combined with other pages and revised at any time.

1. A method for facilitating the creation of: a) an individual or community scrapbook, comprising the storing of data for either several individuals or an individual (member user[s]) into a scrapbook format into a data storage device coupled with a server whereby the server can be accessible by several user interface devices via communication media; and b) a business rule associated with allowing access to the scrapbook site.

2. The method of claim 1, wherein the communication media is the Internet or an Intranet.

3. The method of claim 1, wherein the business rule is created by the company or agency creating and coordinating the scrapbook service.

4. The method of claim 3, further includes: storing the business rule in the data storage device.

5. The method of claim 1, wherein the member user is a group member user or an individual member.

6. The method of claim 5, wherein the individual or group member user(s) designates by the business rule, access by identified people.

7. The method of claim 6, wherein the business rule grants authority to the agency providing the scrapbook services to grant access privileges to identified members and/or discontinue access if so determined by the primary purchaser of the scrapbook service.

8. The method of claim 7 includes; if the scrapbook is purchased by several individuals, all of them will have equal access and privileges to access the scrapbook site.
Additionally, each member will be able to designate access privileges others.

9. The method of claim 1, wherein the data associated with the photos, documents or other materials associated with the scrapbook are stored on the data storage device is divided into files or categories.

10. The method of claim 1, wherein the photos, written materials or other materials are on the data device via scanning or data transfer initiated by the individual or group member users or by the seller/vendor at the direction of the member user(s).

11. The method of claim 1, wherein the materials includes photos, text, graphics, audio, designs or audio-visual items.

12. The method of claim 1, also includes various templates, text, designs and/or graphics that the scrapbooker can combine with photos or other materials to create a custom designed scrapbook page and/or book.

13. The method of claim 1, further includes: receiving an e-mail address of member user(s) during a registration process and storing the email address in the data storage device.

14. The method of claim 13, further allows the company or agency selling the scrapbook service to contact members on a regular basis with updates and further description of services as well as tips and hints on how to electronically scrapbook.

15. The method of claim 1, when the business rule is one of read only and, change or none.

16. The method of claim 16, wherein the communication media is a local network (LAN) or wide area network (WAN).
